(19) United States
(12) Patent Application Publication
(10) Pub. No.: US 2006/0234593 A1
(43) Pub. Date: Oct. 19, 2006

(54) Method for manufacturing plasma display panel and laser head exposer used therefor

(76) Inventor: Jae-Hyung Kim, Chunan-si (KR)

Correspondence Address: LEE & MORSE, P.C., SUITE 2000, 1101 WILSON BOULEVARD, ARLINGTON, VA, 22209, US

(21) Appl. No.: 11/406,395

(22) Filed: Apr. 19, 2006

(30) Foreign Application Priority Data
Apr. 19, 2005 (JP) 10-2005-0032334

(51) Int. Cl. H01J 9/24

(52) U.S. Cl. 445/24

(57) ABSTRACT

A method for manufacturing PDPs minimizes exposure level variances in images formed by a laser head exposer. The exposer includes an exposing region and an adjustment region on at least one side thereof. The exposer used to scan a material layer in a first direction has a first adjustment region, the exposing region and a second adjustment region, arranged along a second direction, perpendicular to the first direction. The method of using the exposer includes directly exposing the material layer along the first direction, shifting the exposer in the second direction, and repeating directly exposing the material layer in a direction parallel to the first direction, wherein a portion of the material layer exposed by one of the first and second adjustment regions during a previous directly exposing is exposed by the other of the first and second adjusting region during a subsequent directly exposing.

### BACKGROUND OF THE INVENTION

1. Field of the Invention

The present invention relates to a plasma display panel. More particularly, the present invention relates to a method of manufacturing a plasma display panel whereby barrier ribs or electrodes of the plasma display panel are fabricated using a direct imaging exposure method, and to a laser head exposer used therefor.

2. Description of the Related Art

A plasma display panel (PDP) is a display device that produces an image via gas discharge. The PDP may include a front substrate and a rear substrate facing the front substrate such that inner surfaces of the front and rear substrates face each other. Barrier ribs between the front and the rear substrates may define a plurality of discharge cells between the inner surfaces of the front and rear substrates to form a discharge space. Sustain electrodes and scan electrodes are placed on the front substrate, and address electrodes are placed on the rear substrate.

The sustain electrodes and the scan electrodes may be formed correspondingly to discharge cells in a direction crossing the address electrodes. The sustain electrodes and the scan electrodes may be covered with a dielectric layer formed on the inner surface of the front substrate, and a protective layer may be formed on top of the dielectric layer. The address electrodes may be covered with a dielectric layer formed on the inner surface of the rear substrate.

A phosphor layer that emits red, green or blue visible light when excited by ultraviolet light may be formed on respective inner surfaces of the barrier ribs that define each discharge cell. The discharge space may be filled with a discharge gas, e.g., a gas mixture of neon, xenon, etc. Each of the scan electrodes and the sustain electrodes may include a transparent electrode for surface discharge and a bus electrode for supplying an electric current to the transparent electrode.

By simultaneously applying address pulses to address electrodes and scan pulses to the scan electrodes corresponding to selected discharge cells, address discharge occurs between the address electrode and the scan electrode, whereby wall charges accumulate in selected discharge cells. Then, by alternately applying sustain pulses between the scan electrode and the sustain electrode for each of the selected discharge cells, sustain discharge is initiated in each of the selected discharge cells when the sum of the voltage of the sustain pulse and the wall voltage produced by the wall charge exceeds firing voltage.

Vacuum ultraviolet light generated from sustain discharge excites the phosphor layer in each of the selected discharge cells so that red, green or blue visible light is emitted from each respective red, green or blue selected discharge cell. The visible light passes through the transparent front substrate having the transparent and bus electrodes, and an image is displayed by the sustain discharges of the selected discharge cells.

The transparent electrodes may be made of a transparent material layer of indium-tin oxide (ITO), to obtain a high transmittance. The bus electrodes may be made of a conductive layer, e.g., a metal, for high electrical conductance.

Photolithography using a photosensitive material has been used for forming the patterns of the transparent electrodes and the bus electrodes on the front substrate and/or for the barrier ribs on the rear substrate, as described below.

In forming the transparent electrodes, a layer of the transparent electrode material may be formed by sputtering on the front substrate. A desired shape of the transparent electrode may be realized by a light exposure and developing process using a photo mask on the front substrate. In forming the bus electrodes, after forming a metal conductive layer on the transparent electrode, a desired shape of the bus electrode may be realized by a light exposure and developing process using a photo mask on the metal conductive layer. In forming the barrier ribs, barrier rib material may be provided on the rear substrate. A desired shape of the barrier rib may be realized by a light exposure and developing process using a photo mask on the rear substrate.

After forming the transparent electrode material the metal conductive layer or the barrier rib material, photolithography using a photosensitive material is performed by repeating multiple processes including applying a photoresist, patterning the photoresist by exposing and developing it with the photo mask, and removing the exposed area by etching. Therefore, a large number of processes are required to form these features, and manufacturing takes a long time.

A direct imaging exposure method is proposed to solve the problems and drawbacks related to using the above described traditional photolithography method using a photosensitive material. Instead of using a photo mask, the direct imaging exposure method directly forms the electrodes or the barrier ribs by directly exposing an electrode material layer or a barrier rib material layer using a laser head exposer. The direct imaging exposure method produces an image by controlling an on-off state of a laser diode provided in the laser head. The electrode material layer or the barrier rib material layer is directly exposed to the image so that the electrodes or the barrier ribs are formed.

In the direct imaging exposure method, the laser head moves in a scanning direction to expose the electrode material layer or the barrier rib material layer in forming the electrodes or the barrier ribs, respectively. Therefore, the direct imaging exposure method produces an overlapped image area in a direction perpendicular to the scanning direction. Accordingly, the overlapped area may be excessively exposed or may be shorter than other areas so that resultant structures, .e.g., the barrier ribs or the electrodes, may have a non-uniform width or stripes may appear in the overlapped area along the scanning direction.

### SUMMARY OF THE INVENTION

The present invention is therefore directed to a method for manufacturing a plasma display panel in which barrier ribs or electrodes are fabricated using a direct imaging exposure method, and a laser head exposer used therefore, which substantially overcome one or more of the problems due to the limitations and disadvantages of the related art.

It is therefore a feature of an embodiment of the present invention to provide a method for manufacturing a plasma display panel in which a difference in exposure level between overlapped areas and non-overlapped areas formed along the scanning direction of a laser head exposer is minimized, and the laser head exposer used therefor.

At least one of the above and other features and advantages of the present invention may be realized by providing a method of manufacturing a plasma display panel, including providing a first plate, providing a second plate, providing address electrodes, barrier ribs, sustain electrodes and scan electrodes defining discharge cells between the first and second plates, and joining the first plate and second plates to each other at their edges, with the discharge cells there between, wherein at least one of providing address electrodes, barrier ribs, sustain electrodes and scan electrodes includes forming a material layer on a substrate, directly exposing the material layer while scanning in a first direction using a laser head exposer, the laser head exposer including a first adjustment region, an exposing region and a second adjustment region arranged along a second direction, perpendicular to the first direction, shifting, after directly exposing, the laser head exposer in the second direction, and repeating the directly exposing in a direction parallel to the first direction, wherein a portion of the material layer exposed by one of the first and second adjustment regions during a previous directly exposing is exposed by the other of the first and second adjusting region during a subsequent directly exposing.

The material layer may be a material for forming the barrier ribs. The directly exposing may include using a plurality of laser head exposers positioned at equal intervals along the substrate in the second direction.

At least one of the above and other features and advantages of the present invention may be realized by providing a laser head exposer for forming an image by directly exposing a material layer formed on a substrate while scanning the substrate, the laser head exposer including an exposing portion having a plurality of on-off controlled laser diodes, and an adjusting region which is on-off controlled by the laser diodes and is located on at least one side of the laser head exposer.

The adjusting region may be formed on at least one side of the laser head exposer along a direction perpendicular to the scanning direction. The adjusting region may include a first adjusting region and a second adjusting region formed on opposite sides of the laser head exposer along the direction perpendicular to the scanning direction. The first and adjusting regions may be identical, may have different shapes, may be substantially mirror images of one another and may be substantially complementary images.

The first and second adjusting regions may be linear along the scanning direction. The first adjusting region may include first protrusions that protrude in the direction perpendicular to the scanning direction and are located at multiple positions along the scanning direction, and the second adjusting region may be linear along the scanning direction. The first adjusting region may be linear along the scanning direction, and the second adjusting region includes first grooves that are recessed in the direction perpendicular to the scanning direction and are located at multiple positions along the scanning direction. The first adjusting region may include first grooves that are recessed in the direction perpendicular to the scanning direction and are located at multiple positions along the scanning direction, and the second adjusting region includes second grooves that are recessed in the direction perpendicular to the scanning direction, located at multiple positions along the scanning direction and symmetrical with the first grooves. The first adjusting region may include first protrusions that protrude in the direction perpendicular to the scanning direction and are located at multiple positions along the scanning direction, and the second adjusting region may include first grooves that are recessed in the direction perpendicular to the scanning direction, located at plural positions along the scanning direction and symmetrical to the first protrusions. The first adjusting region may be a reverse triangle having a width that increases gradually along the scanning direction, and the second adjusting region may be a triangle having a width that decreases gradually along the scanning direction. The first adjusting region may be a triangle having a width that decreases gradually along the scanning direction, and the second adjusting region may be a reverse triangle having a width that increases gradually along the scanning direction. The first adjusting region may be two triangles arranged such that the width of the first adjusting region increases gradually and then decreases gradually along the scanning direction, and the second adjusting region may be two triangles arranged such that the width of the second adjusting region decreases gradually and then increases gradually along the scanning direction, and wherein the two triangles of the second adjusting region are formed to correspond to the two triangles of the first adjusting region.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial, perspective view of a PDP manufactured according to an embodiment of the present invention;

FIG. 2 illustrates a flowchart of a PDP manufacturing process according to an embodiment of the present invention;

FIG. 3 illustrates a direct imaging exposure method according to an embodiment of the present invention;

FIG. 4 illustrates a plan view of a first embodiment of a laser head exposer used in the direct imaging exposure method of FIG. 3;

FIG. 5 illustrates the laser head exposer of FIG. 4 exposing barrier ribs;

FIG. 6A illustrates a plan view of a second embodiment of a laser head exposer;

FIG. 6B illustrates the laser head exposer of FIG. 6A exposing barrier ribs;

FIG. 7A illustrates a plan view of a third embodiment of a laser head exposer;

FIG. 7B illustrates the laser head exposer of FIG. 7A exposing barrier ribs;

FIG. 8A illustrates a plan view of a fourth embodiment of a laser head exposer;

FIG. 8B illustrates the laser head exposer of FIG. 8A exposing barrier ribs;

FIG. 9A illustrates a plan view of a fifth embodiment of a laser head exposer;

FIG. 9B illustrates the laser head exposer of FIG. 9A exposing barrier ribs; and

FIG. 10 illustrates a plan view of a sixth embodiment of a laser head exposer;

FIG. 11 illustrates a plan view of a seventh embodiment of a laser head exposer; and

FIG. 12 illustrates a plan view of an eighth embodiment of a laser head exposer.

### DETAILED DESCRIPTION OF THE INVENTION

Korean Patent Application No. 10-2005-0032334, filed on Apr. 19, 2005, in the Korean Intellectual Property Office, and entitled “Method for Manufacturing Plasma Display Panel and Laser Head Exposer Used Therefor”, is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “on” or “under” another layer, it can be directly on or under, and one or more intervening layers may also be present. In addition, it will also be understood that when a layer is referred to as being “between” two layers, it can be the only layer between the two layers, or one or more intervening layers may also be present. Like reference numerals refer to like elements throughout.

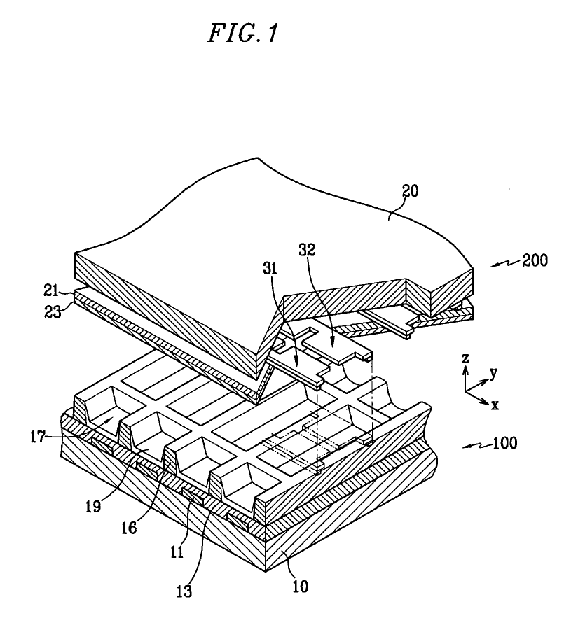

Referring to FIG. 1, a plasma display panel (PDP) manufactured according to an embodiment of the present invention may include a first substrate 10 (hereinafter, referred to as a “rear substrate”) and a second substrate 20 (hereinafter, referred to as a “front substrate”) placed facing and parallel to each other and joined at their edges. Barrier ribs 16 may be formed between the rear substrate 10 and the front substrate 20 to define a plurality of discharge cells 17 between inner surfaces of the front and rear substrates to form a discharge space. A phosphor layer 19 that emits red, green or blue visible light when excited by ultraviolet light generated during plasma discharge may be respectively formed in each discharge cell 17.

A first electrode 31 (hereinafter, referred to as a “sustain electrode”), a second electrode 32 (hereinafter, referred to as a “scan electrode”), and an address electrode 11 may be provided for each discharge cell 17 so as to be capable of plasma discharge and generate ultraviolet light rays to collide with and excite the phosphor layer 19 in each discharge cell 17.

Address electrodes 11 may be formed such that each address electrode extends in one direction (y-direction in the drawing) on the rear substrate 10 and arranged correspondingly to each discharge cell 17 in the x-direction in FIG. 1. The address electrodes 11 may be covered with a dielectric layer 13 that serves to protect the address electrodes 11 from discharge and to accumulate wall charges. The barrier ribs 16 defining the discharge cells 17 may be formed on top of the dielectric layer 13. The phosphor layer 19 may be coated on the inside surfaces of each discharge cell 17, viz., on inner walls of the barrier ribs 16 and on the dielectric layer 13 surrounded by the barrier ribs 16 in each discharge cell 17.

A rear plate 100 may include the rear substrate 10, the address electrodes 11, the dielectric layer 13, the barrier ribs 16 and the phosphor layer 19.

The sustain electrodes 31 and scan electrodes 32 may be formed on an inner surface of the front substrate 20, i.e., the surface facing the rear substrate 10. The sustain electrodes 31 and the scan electrodes 32 may be formed extending in a direction (x-direction in FIG. 1) crossing the address electrodes 11, and may be arranged correspondingly to sides of each discharge cell 17 in the y-direction in FIG. 1.

The sustain electrodes 31 and the scan electrodes 32 may be covered with a dielectric layer 21 that serves to protect the sustain electrodes 31 and the scan electrodes 32 from discharge and to accumulate wall charges. A MgO protective layer may be coated on the dielectric layer 21 for protecting the dielectric layer 21 and for improving performance by enhancing secondary electron emission coefficient.

A front plate 200 may include the front substrate 20, the sustain electrodes 31, the scan electrodes 32, the dielectric layer 21 and the MgO protective layer 23.

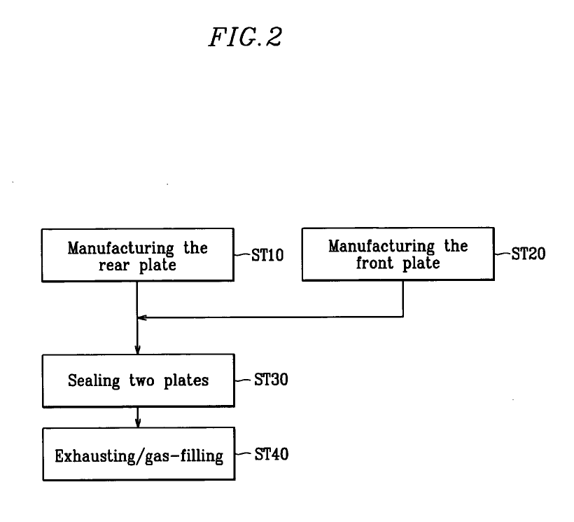

Referring to FIGS. 2 to 4, a manufacturing method of the PDP according to an embodiment of the present invention may include a step ST10 for manufacturing the rear plate, a step ST20 for manufacturing the front plate, a step ST30 for sealing the two plates, and a step ST40 for exhausting/gas-filling. In step ST10 for manufacturing the rear plate, the address electrodes 11 and the barrier ribs 17 may be formed on the rear substrate 10. In step ST20 for manufacturing the front plate, the sustain electrodes 31, the scan electrodes 32, the dielectric layer 21, and the MgO protective layer 23 may be formed on the front substrate 20. The rear plate 100 and the front plate 200 may then be joined to each other at their edges and sealed in step ST30 for sealing the two plates. In step ST40 for exhausting/gas-filling, the space between the rear plate 100 and the front plate 200 may be exhausted through an exhausting hole of the PDP and then filled with a discharge gas. The PDP may be finished by sealing the exhausting hole.

A detailed description will now be provided for exemplary embodiments of the present invention in which a direct imaging exposure method may be applied to the manufacturing process of the plasma display panel.

The direct imaging exposure method according to the present invention may be applied in step ST10 for manufacturing the rear plate, in particular, to form the barrier ribs 16 on the rear substrate 10, and may be applied in step ST20 for manufacturing the front plate, in particular, to form the sustain electrodes 31 and the scan electrodes 32 on the front substrate 20. For convenience, the forming process of the barrier ribs 16 on the rear substrate 10 is exemplarily described hereinafter.

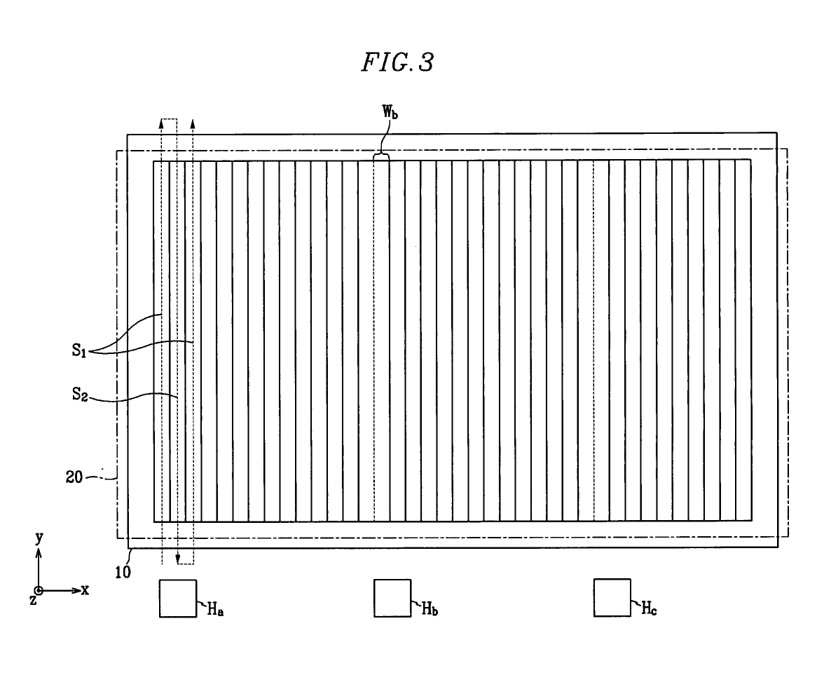

The direct imaging exposure method is a method in which a material layer formed on the rear substrate 10 is directly exposed to the image formed by a laser head exposer. The laser head exposer H may have a predetermined band width W_{b}, as shown in FIG. 3, and may expose the material layer while moving in a first direction (y-direction in FIGS. 3-5). A well-known etching method may be used to remove and eliminate the exposed parts after the exposing process.

When the barrier ribs 16 are formed by the direct imaging exposure method, the material layer is made of a barrier rib material. When the sustain and scan electrodes 31 and 32 are formed, the material layer is made of an electrode material.

The direct imaging exposure method may include a first scanning exposure S₁ and a second scanning exposure S₂. In other words, the laser head exposer H may perform the first scanning exposure S₁ while moving over the rear substrate 10 in a first direction (+y-direction in FIGS. 3-5). Then, the laser head exposer H may be shifted in a second direction (x-direction in FIGS. 3-5) perpendicular to the first direction (y-direction in FIGS. 3-5) and may perform the second scanning exposure S₂ while moving in a third direction (−y-direction in the drawing) opposite, but parallel, to the first direction (+y-direction in the drawing). The first scanning exposure S₁ and the second scanning exposure S₂ may be sequentially repeated, as show in FIG. 3.

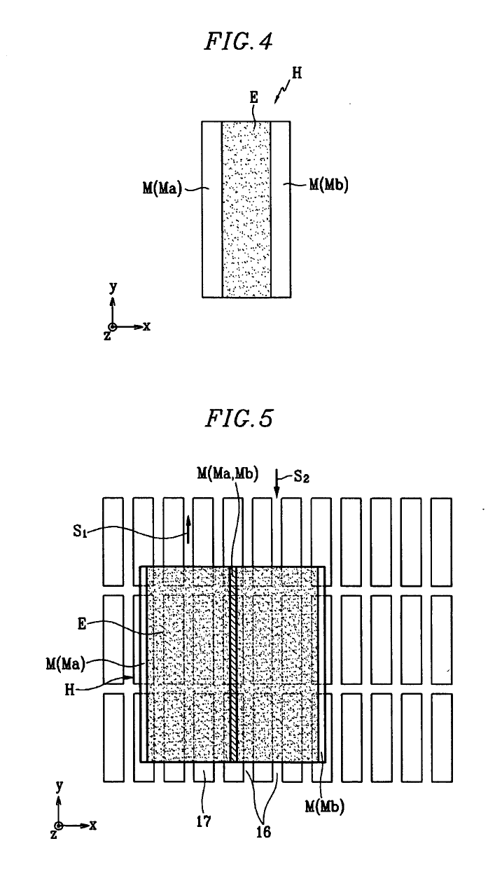

The laser head exposer H may be provided with a plurality of laser diodes that produce the exposed image by selective on-off control. As shown in FIG. 4, the laser head exposer H may include an exposing part E and an adjusting region M having two regions, viz., Ma and Mb. The exposure may be carried out substantially by the exposing part E using on-off control of the laser diodes. The adjusting regions Ma and Mb may be positioned on both sides of the exposing part E and may adjust the exposure by the on-off controlling of the laser diodes.

Referring to FIG. 5, in a manufacturing method of a PDP according to an embodiment of the present invention, the adjusting region M(Ma) in one side of the laser head exposer H at the second scanning exposure S₂ may be positioned to overlap the adjusting region M(Mb) in the other side of the laser head exposer H at the first scanning exposure S₁ when the laser head exposer H shifts in the x-direction between the first scanning exposure S₁ and the second scanning exposure S₂.

Overlapping two adjusting regions Ma and Mb minimizes the difference in exposure level between the overlapped areas and the non-overlapped areas of images made by the laser head exposer. As shown in FIG. 5, barrier ribs 16 may be formed to a uniform width by overlapping the adjusting regions Ma and Mb such that a portion of material exposed by the second adjusting region Mb of a previous direct scanning exposure will be exposed by the first adjusting region Ma of a subsequent direct scanning exposure. In FIG. 5, the overlap region is indicated by cross-hatching.

The first scanning exposure S₁ and the second scanning exposure S₂ may be carried out by a plurality of laser head exposers H positioned at equal intervals along one edge of the rear substrate 10. FIG. 3 illustrates an example of three laser head exposers Ha, Hb and Hc located at intervals equal to one-third (⅓) of the span of the rear substrate 10. Accordingly, the use of a plurality of the laser head exposers H may reduce the number of processes for the first scanning exposure S₁ and the second scanning exposure S₂. In the present embodiment, three laser head exposers H may reduce the number of processes for the first scanning exposure S₁ and the second scanning exposure S₂ to ⅓ of that using a single laser head exposer H.

The laser head exposer H forms the exposed part E and the adjusting region M by on-off controlling of the laser diodes in the laser head. Further, the adjusting region M may be formed into various shapes for minimizing the difference in exposure level between the overlapped areas and the non-overlapped areas of the images.

Further, the laser head exposer H may minimize the difference in exposure level between the overlapped areas and the non-overlapped areas of the images by tilting the angle of a laser beam emitted from the laser diode (not shown).

Hereinafter, the various embodiments of the exposing part E and the adjusting region M formed by the laser head exposer H will be described. The adjusting region M may be formed on either side or both sides of the image formed by on-off controlling the laser diodes. That is, the adjusting region M may be formed on either side or both sides along the direction (x-direction) that is perpendicular to the scanning direction (y-direction) of the laser head exposer H.

If the adjusting region M is formed on both sides along the direction perpendicular to the scanning direction, the adjusting region M may include a first adjusting region Ma formed on one side of the laser head exposer H and a second adjusting region Mb formed on the other side of the laser head exposer H, along the x-direction. Also, the first adjusting region Ma may be formed to be identical with the second adjusting region Mb or may be different from the second adjusting region Mb.

As shown in FIG. 4, a first adjusting region Ma and a second adjusting region Mb may be a linear along the scanning direction (y-direction).

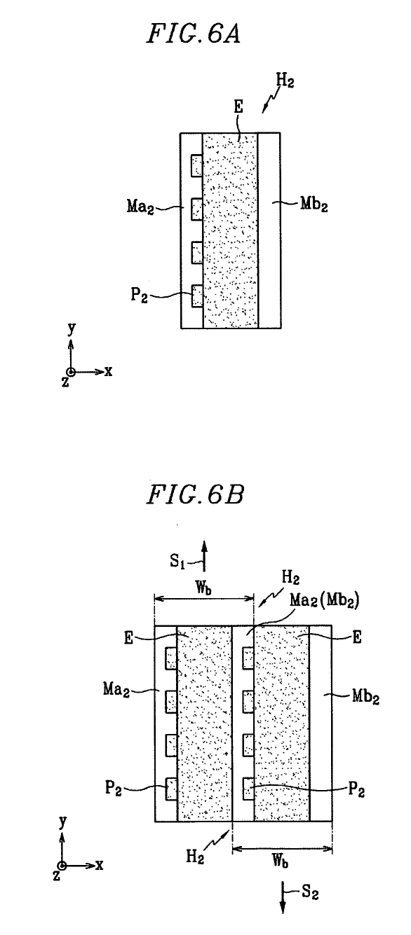

FIG. 6A illustrates a plan view of a second embodiment of a laser head exposer H₂. As shown in FIG. 6A, a first adjusting region Ma₂ may have a different shape from a second adjusting region Mb₂, each positioned on the respective sides of the exposing part E in the laser head exposer H₂.

The first adjusting region Ma₂ may include first protrusions P₂ that protrude in the direction (x-direction) perpendicular to the scanning direction (y-direction) and are located at multiple positions along the scanning direction (y-direction). The second adjusting region Mb₂ may be linear along the scanning direction (y-direction).

FIG. 6B illustrates the first adjusting region Ma₂ and the second adjusting region Mb₂ overlapping each other during the first scanning exposure S₁ and the second scanning exposure S₂. During the second scanning exposure S₂, the first adjusting region Ma₂ having first protrusions P₂ may pass over and overlap the area passed over by the second adjusting region Mb₂ during the first scanning exposure S₁.

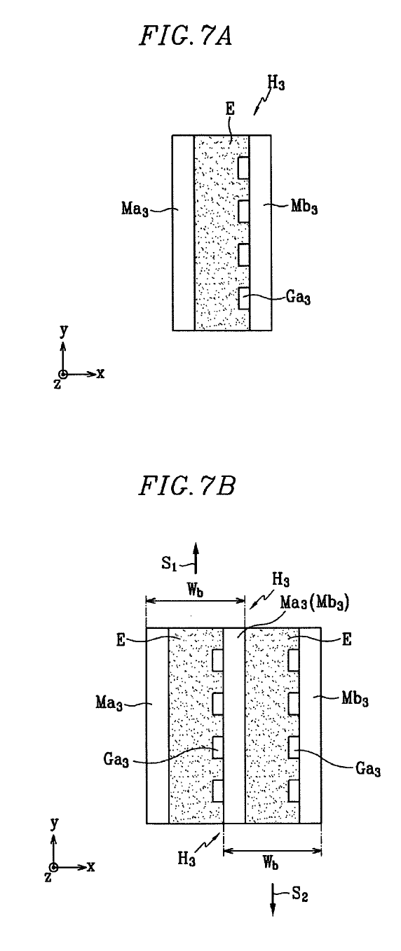

FIG. 7A illustrates a plan view of a third embodiment of a laser head exposer H₃. As shown in FIG. 7A, a first adjusting region Ma₃ is different in shape from a second adjusting region Mb₃, each positioned at the respective sides of the exposing part E in the laser head exposer H₃.

The first adjusting region Ma₃ may be linear along the scanning direction (y-direction). The second adjusting region Mb₃ may include first grooves Ga₃ that are recessed in the direction (x-direction) perpendicular to the scanning direction (y-direction) and are located at multiple positions along the scanning direction (y-direction).

FIG. 7B illustrates the first adjusting region Ma₃ and the second adjusting region Mb₃ overlapping with each other during a first scanning exposure S₁ and a second scanning exposure S₂. During the second scanning exposure S₂, the first adjusting region Ma₃ having a linear shape may pass over and overlap the area passed over by the second adjusting region Mb₃ having first grooves Ga₃ during the first scanning exposure S₁.

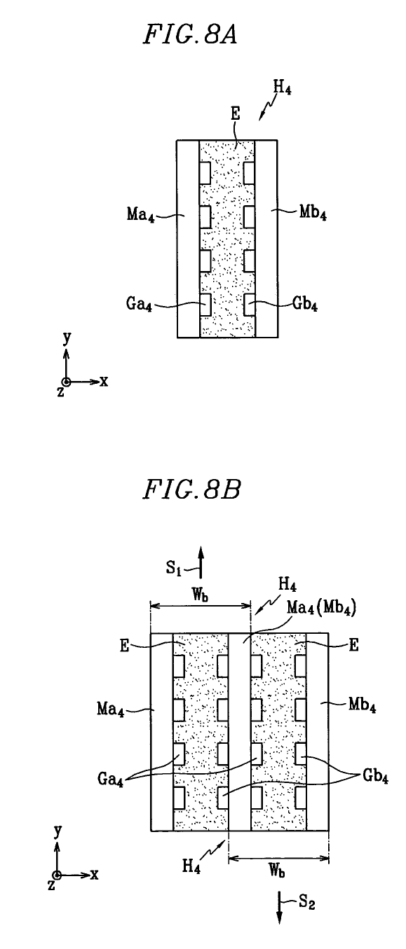

FIG. 8A illustrates a plan view of a fourth embodiment of a laser head exposer H₄. As shown in FIG. 8A, a first adjusting region Ma₄ is identical in shape with a second adjusting region Mb₄, each positioned on the respective sides of the exposing part E in the laser head exposer H₄.

The first adjusting region Ma₄ may include first grooves Ga₄ that are recessed in the direction (x-direction) perpendicular to the scanning direction (y-direction) and are located at multiple positions along the scanning direction (y-direction). The second adjusting region Mb₄ may also include second grooves Gb₄ that are recessed in the direction (x-direction) perpendicular to the scanning direction (y-direction), located at multiple positions along the scanning direction (y-direction) and formed to be symmetrical and mirror image to the first grooves Ga₄.

FIG. 8B illustrates the first adjusting region Ma₄ and the second adjusting region Mb₄ overlapping with each other during the first scanning exposure S₁ and the second scanning exposure S₂. During the second scanning exposure S₂, the first adjusting region Ma₄ having first grooves Ga₄ may pass over and overlap the area passed over by the second adjusting region Mb₄ having second grooves Gb₄ during the first scanning exposure S₁.

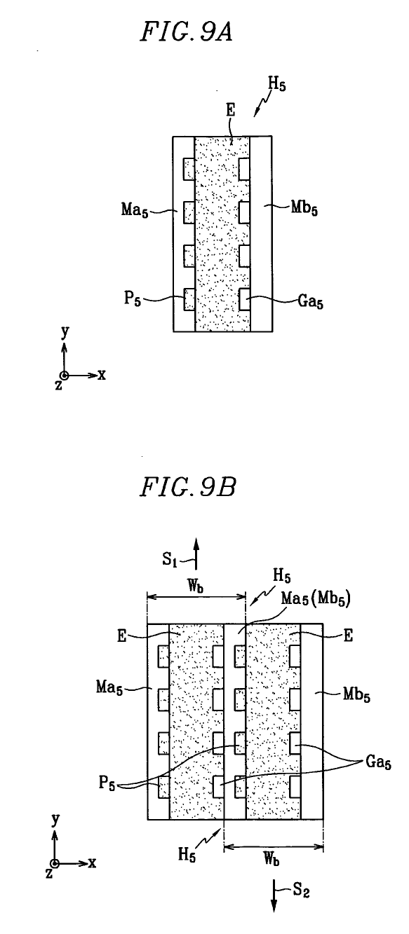

FIG. 9A illustrates a plan view of a fifth embodiment of a laser head exposer according H₅. As shown in FIG. 9A, a first adjusting region Ma₅ is different in shape from a second adjusting region Mb₅, each positioned on the respective sides of the exposing part E in the laser head exposer H₅.

The first adjusting region Ma₅ may include first protrusions P₅ that protrude in the direction (x-direction) perpendicular to the scanning direction (y-direction) and are located at multiple positions along the scanning direction (y-direction). The second adjusting region Mb₅ may include first grooves Ga₅ that are recessed in the direction (x-direction) perpendicular to the scanning direction (y-direction) and are located at multiple positions along the scanning direction (y-direction).

FIG. 9B illustrates the first adjusting region Ma₅ and the second adjusting region Mb₅ overlapping with each other during the first scanning exposure S₁ and the second scanning exposure S₂. During the second scanning exposure S₂, the first adjusting region Ma₅ having first protrusions P₅ may pass over and overlap the area passed over by the second adjusting region Mb₅ having first grooves Ga₅ during the first scanning exposure S₁.

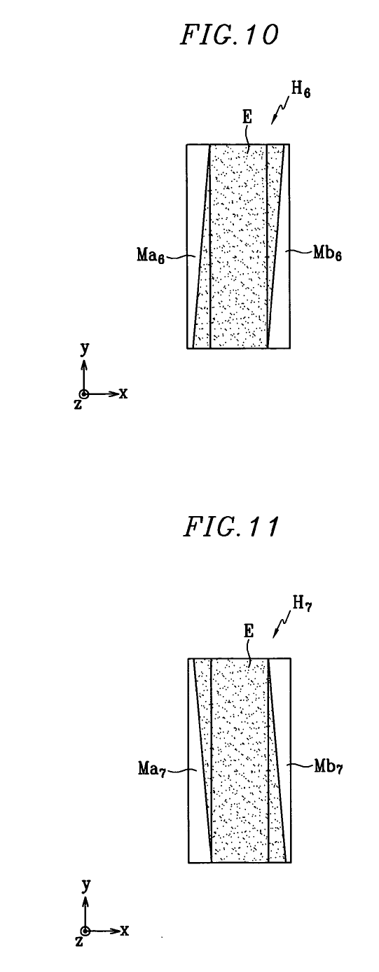

FIG. 10 illustrates a plan view of a sixth embodiment of a laser head exposer H₆. As shown in FIG. 10, a first adjusting region Ma₆ is different in shape from a second adjusting region Mb₆, each positioned on the respective sides of the exposing part E in the laser head exposer H₆.

The first adjusting region Ma₆ may be formed as a reverse triangle having a width that increases gradually along the scanning direction (y-direction), and the second adjusting region Mb₆ may be formed as a triangle having a width that decreases gradually along the scanning direction (y-direction).

FIG. 11 illustrates a plan view of a seventh embodiment of a laser head exposer H₇. As shown in FIG. 11, a first adjusting region Ma₇ is different in shape from a second adjusting region Mb₇, each positioned on the respective sides of the exposing part E in the laser head exposer H₇.

The first adjusting region Ma₇ may be formed as a triangle having a width that decreases gradually along the scanning direction (y-direction), and the second adjusting region Mb₇ may be formed as a reverse triangle having a width that increases gradually along the scanning direction (y-direction).

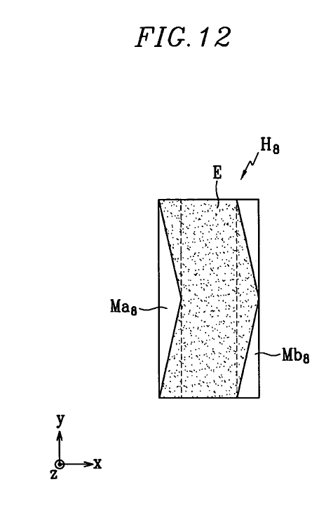

FIG. 12 illustrates a plan view of an eighth embodiment of a laser head exposer H₈. As shown in FIG. 12, a first adjusting region Ma₈ is different in shape from a second adjusting region Mb₈, each positioned on the respective sides of the exposing part E in the laser head exposer H₈.

The first adjusting region Ma₈ may be formed as a shape made of two triangles in a manner such that the width of the first adjusting region Ma₈ increases gradually and then decreases gradually along the scanning direction (y-direction). The second adjusting region Mb₈ may also be formed as a shape made of two triangles but in a manner such that the width of the second adjusting region Mb₈ decreases gradually and then increases gradually along the scanning direction (y-direction). The two triangles of the second adjusting region Mb₈ may be formed corresponding to the two triangles of the first adjusting region Ma₈.

According to the embodiments of the present invention, as explained hereinabove, an adjusting region positioned at one side of the laser head exposer at the first scanning exposure overlaps with an adjusting region positioned at the other side of the laser head exposer at the second scanning exposure when the laser head exposer shifts between the first scanning exposure and the second scanning exposure. As shown in the above examples, the opposite adjusting regions may have identical shapes, different shapes, substantially mirrored shapes or substantially complementary shapes.

In this manner, the difference in exposure level between the overlapped areas and the non-overlapped areas formed along the scanning direction of the laser head exposer may be minimized. Thus, barrier ribs or electrodes formed in accordance with embodiments of the present invention may have a uniform width.

Exemplary embodiments of the present invention have been disclosed herein, and although specific terms are employed, they are used and are to be interpreted in a generic and descriptive sense only and not for purpose of limitation. For example, the address electrode may also be formed using the laser head exposure in accordance with embodiments of the present invention. Accordingly, it will be understood by those of ordinary skill in the art that various changes in form and details may be made without departing from the spirit and scope of the present invention as set forth in the following claims.

What is claimed is:

1. A method of manufacturing a plasma display panel, comprising:
providing a first plate,
providing a second plate,
providing address electrodes, barrier ribs, sustain electrodes and scan electrodes defining discharge cells between the first and second plates, and
joining the first plate and second plates to each other at their edges, with the discharge cells there between
wherein at least one of providing address electrodes, barrier ribs, sustain electrodes and scan electrodes includes:
forming a material layer on a substrate;
directly exposing the material layer while scanning in a first direction using a laser head exposer, the laser head exposer including a first adjustment region, an exposing region and a second adjustment region arranged along a second direction, perpendicular to the first direction;
shifting, after directly exposing, the laser head exposer in the second direction; and
repeating the directly exposing in a direction parallel to the first direction,
wherein a portion of the material layer exposed by one of the first and second adjustment regions during a previous directly exposing is exposed by the other of the first and second adjusting region during a subsequent directly exposing.

2. The method of manufacturing a plasma display panel as claimed in claim 1, wherein the material layer is a material for forming the barrier ribs.

3. The method of manufacturing a plasma display panel as claimed in claim 1, wherein the directly exposing includes using a plurality of laser head exposers positioned at equal intervals along the substrate in the second direction.

4. A laser head exposer for forming an image by directly exposing a material layer formed on a substrate while scanning the substrate, the laser head exposer comprising:
an exposing portion having a plurality of on-off controlled laser diodes; and
an adjusting region which is on-off controlled by the laser diodes and is located on at least one side of the laser head exposer.

5. The laser head exposer as claimed in claim 4, wherein the adjusting region is formed on at least one side of the laser head exposer along the direction perpendicular to the scanning direction.

6. The laser head exposer as claimed in claim 4, wherein the adjusting region includes a first adjusting region and a second adjusting region formed on opposite sides of the laser head exposer along the direction perpendicular to the scanning direction.

7. The laser head exposer as claimed in claim 6, wherein the first adjusting region and the second adjusting region are identical in shape.

8. The laser head exposer as claimed in claim 6, wherein the first adjusting region and the second adjusting region are linear along the scanning direction.

9. The laser head exposer as claimed in claim 6, wherein the first adjusting region includes first protrusions that protrude in a direction perpendicular to the scanning direction and are located at multiple positions along the scanning direction, and the second adjusting region is linear along the scanning direction.

10. The laser head exposer as claimed in claim 6, wherein the first adjusting region is linear along the scanning direction, and the second adjusting region includes first grooves that are recessed in the direction perpendicular to the scanning direction and are located at multiple positions along the scanning direction.

11. The laser head exposer as claimed in claim 6, wherein the first adjusting region includes first grooves that are recessed in the direction perpendicular to the scanning direction and are located at multiple positions along the scanning direction, and the second adjusting region includes second grooves that are recessed in the direction perpendicular to the scanning direction, located at multiple positions along the scanning direction and symmetrical with the first grooves.

12. The laser head exposer as claimed in claim 6, wherein the first adjusting region includes first protrusions that protrude in the direction perpendicular to the scanning direction and are located at multiple positions along the scanning direction, and the second adjusting region includes first grooves that are recessed in the direction perpendicular to the scanning direction, located at plural positions along the scanning direction and symmetrical to the first protrusions.

13. The laser head exposer as claimed in claim 6, wherein the first adjusting region is formed as a reverse triangle having a width that increases gradually along the scanning direction, and the second adjusting region is formed as a triangle having a width that decreases gradually along the scanning direction.

14. The laser head exposer as claimed in claim 6, wherein the first adjusting region is formed as a triangle having a width that decreases gradually along the scanning direction, and the second adjusting region is formed as a reverse triangle having a width that increases gradually along the scanning direction.

15. The laser head exposer as claimed in claim 6, wherein the first adjusting region is formed as a shape made of two triangles in a manner such that the width of the first adjusting region increases gradually and then decreases gradually along the scanning direction, and the second adjusting region is formed as a shape made of two triangles in a manner such that the width of the second adjusting region decreases gradually and then increases gradually along the scanning direction, and wherein the two triangles of the second adjusting region are formed to correspond to the two triangles of the first adjusting region.

16. The laser head exposer as claimed in claim 6, wherein the first adjusting region and the second adjusting region have different shapes.

17. The laser head exposer as claimed in claim 16, wherein the first adjusting region and the second adjusting region are substantially mirror images of one another.

18. The laser head exposer as claimed in claim 16, wherein the first adjusting region and the second adjusting region are substantially complementary images.
